(19) United States
(12) Patent Application Publication
(10) Pub. No.: US 2026/0343304 A1
(43) Pub. Date: Oct. 29, 2026

(54) UE APPARATUS SELECTION IN A WIRELESS COMMUNICATIONS NETWORK

(71) Applicant: Lenovo (Singapore) Pte. Ltd., Singapore (SG)

(72) Inventors: Ishan Vaishnavi, München (DE); Andreas Kunz, Ladenburg (DE); Dimitrios Karampatsis, Ruislip (GB)

(21) Appl. No.: 19/110,029

(22) PCT Filed: Oct. 20, 2022
(86) PCT No.: PCT/EP2022/079310

§ 371 Date: Mar. 7, 2025

(30) Foreign Application Priority Data
Sep. 8, 2022 (GR) 20220100734

(51) Int. Cl. H04W 28/02

(52) U.S. Cl. CPC H04W 28/0215

(57) ABSTRACT

There is provided a network entity in a wireless communication network. The network entity comprises a processor coupled with a memory and configured to cause the network entity to receive information comprising one or more selection criteria for selecting one or more UEs, and message information related to one or more messages that are to be sent to one or more UEs. The processor is configured to acquire a UE list based at least in part on the received information, the UE list indicating one or more UEs each of which satisfies the one or more selection criteria and is technically capable of receiving the one or more messages.

### FIELD

The subject matter disclosed herein relates generally to the field of providing a list of user equipment, UE, apparatuses, in particular UE apparatuses that satisfy one or more selection criteria.

### BACKGROUND

Operators of wireless communication networks have data about certain UE behaviours. For example, an operator may have information regarding which UE is present at a given tracking are, which access networks a UE connects to, and/or which Network Slice Instances, NSIs, a UE is a part of.

In TS23.288, this data is predominantly used for fixing network issues and/or improving network performance.

### SUMMARY

Disclosed herein are procedures for providing a list of UE apparatuses, in particular UE apparatuses that satisfy one or more selection criteria. Said procedures may be implemented by a network entity in a wireless communications network.

In an aspect, there is provided a network entity in a wireless communication network. The network entity comprises a receiver and a processor. The receiver is arranged to receive information. The information comprises one or more selection criteria for selecting one or more UE apparatuses, and message information related to one or more messages that are to be sent to one or more UE apparatuses. The processor is arranged to, using some or all of the received information, acquire a UE apparatus list, the UE apparatus list indicating one or more UE apparatuses each of which satisfies the one or more selection criteria and is technically capable of receiving the one or more messages.

In a further aspect, there is provided a method performed in a wireless communication network. The method comprises receiving information comprising one or more selection criteria for selecting one or more UE apparatuses and message information related to one or more messages that are to be sent to one or more UE apparatuses, and, using some or all of the received information, acquiring a UE apparatus list, the UE apparatus list indicating one or more UE apparatuses, each of which satisfies the one or more selection criteria and is technically capable of receiving the one or more messages.

In a further aspect, there is provided a network entity in a wireless communication network. The network entity comprises a receiver and a transmitter. The receiver is arranged to receive information comprising one or more selection criteria for selecting one or more UE apparatuses and message information related to one or more messages that are to be sent to one or more UE apparatuses. The transmitter is arranged to send, to a further entity in wireless communication network, a request for a UE apparatus list, the UE apparatus list indicating one or more UE apparatuses each of which satisfies the one or more selection criteria and each of which is technically capable of receiving the one or more messages. The receiver is further arranged to receive, from the further entity, the UE apparatus list.

In a further aspect, there is provided a method performed in a wireless communication network. The method comprises: receiving information, the information comprising one or more selection criteria for selecting one or more user equipment, UE, apparatuses and message information related to one or more messages that are to be sent to one or more UE apparatuses; sending, to a further entity in wireless communication network, a request for a UE apparatus list, the UE apparatus list indicating one or more UE apparatuses each of which satisfies the one or more selection criteria and each of which is technically capable of receiving the one or more messages; and receiving, from the further entity, the UE apparatus list.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for providing a list of UE apparatuses that satisfy one or more selection criteria will now be described, by way of example only, with reference to the accompanying drawings, in which:

FIG. 1 depicts an embodiment of a wireless communication system;

FIG. 2 depicts a user equipment apparatus;

FIG. 3 depicts a network node;

FIG. 4 illustrates an approach for deriving and providing analytics to an Analytics Consumer NF based on 3GPP TS 23.288 v17.2.0;

FIG. 5 illustrates a Management Data Analytics (MDA) functional overview and service framework;

FIG. 6 illustrates scenario in which methods and apparatuses for providing a list of UE apparatuses that satisfy one or more selection criteria are implemented;

FIG. 7 depicts certain steps of a method in which a list of UE apparatuses that satisfy one or more selection criteria is provided;

FIG. 8 is a process flow chart showing certain steps of a further method performed in the wireless communication system; and

FIG. 9 is a process flow chart showing certain steps of a yet further method performed in the wireless communication system.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

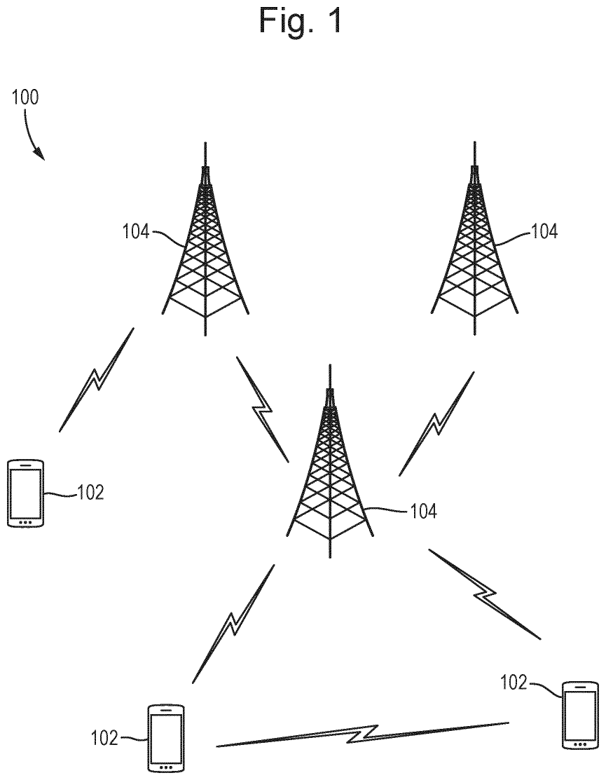

FIG. 1 depicts an embodiment of a wireless communication system 100 for implementing procedures for providing a list of UE apparatuses, in particular UE apparatuses that satisfy one or more selection criteria. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

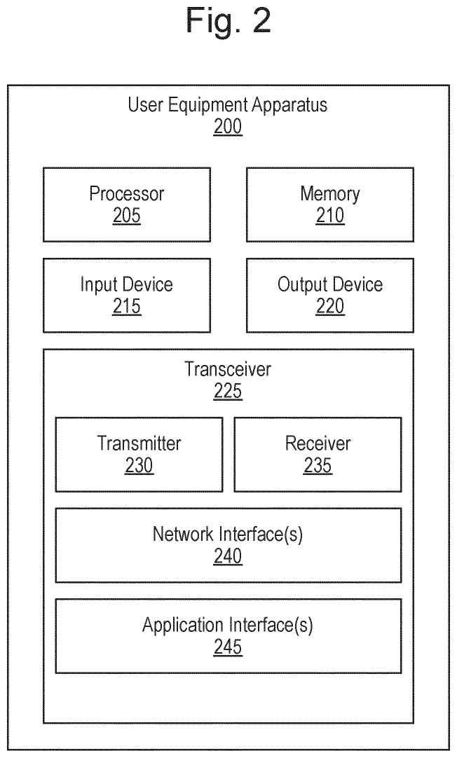

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be in accordance with the remote unit 102 of FIG. 1. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

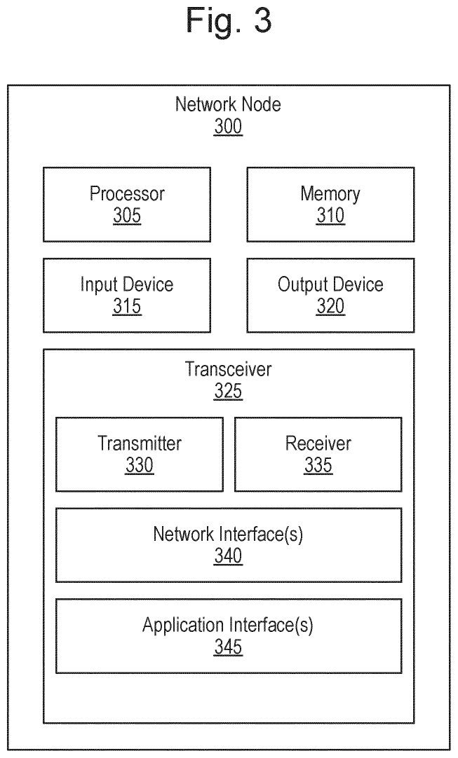

FIG. 3 depicts further details of the network node 300 that may be used for implementing the methods described herein. The network node 300 may be one implementation of an entity in the wireless communications network, e.g. in one or more of the wireless communications networks described herein, e.g. the wireless network 100 of FIG. 1. The network node 300 may be, for example, the UE apparatus 200 described above, or a Network Function (NF) or Application Function (AF), or another entity, of one or more of the wireless communications networks of embodiments described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

Operators of wireless communications networks, e.g. the wireless network 100 of FIG. 1, typically have or are able to acquire data about certain UE behaviours. 5G enables the collection and use of analytics in both the control and management planes. An operator may have data regarding which UE is present at which tracking area, which access networks a UE connects to, and/or which NSIs a UE is a part of. In TS23.288, the data is predominantly used for fixing network issues, improving network performance, and/or improving service quality. The present disclosure uses the data for other beneficial purposes.

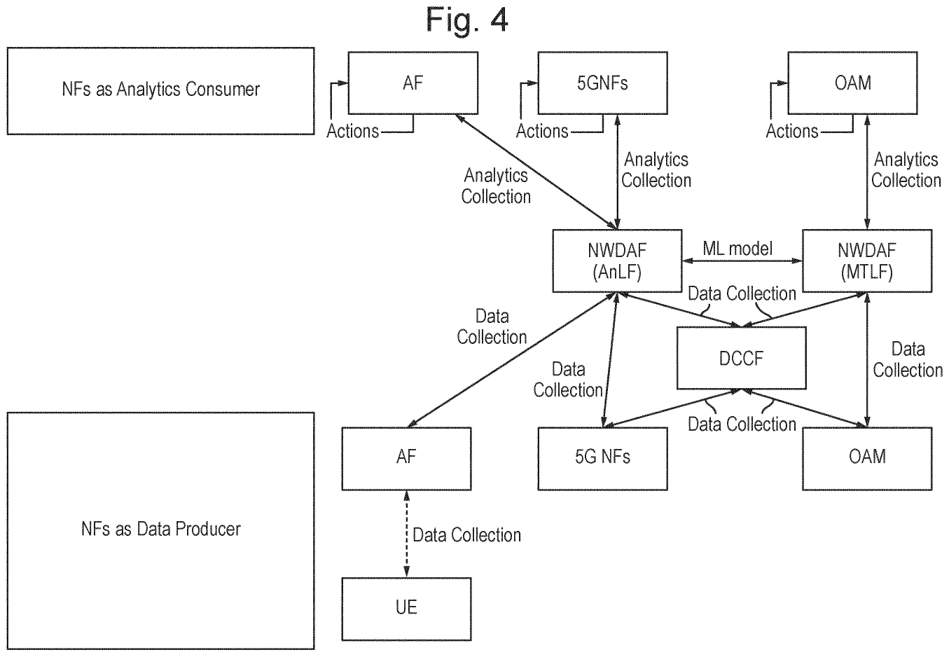

In the current Release 16 and Release 17 3GPP architecture, the network data analytics function (NWDAF), which may be as defined in 3GPP TS 23.288 v17.2.0, provides analytic output to one or more Analytics Consumer network functions (NFs) based on data collected from one or more Data Producer NFs. This is illustrated schematically in FIG. 4. FIG. 4 is a schematic illustration (not to scale) illustrating a conventional approach of deriving and providing analytics to an Analytics Consumer NF. The approach illustrated in FIG. 4 is based on 3GPP TS 23.288 v17.2.0, the contents of which are incorporated herein by reference.

In addition, the NWDAF may provide area-related analytics, such as a number of UEs predicted to be in a certain area at a certain time interval. In TS23.288, this procedure is for the NWDAF, providing statistics or predictions on the number of UEs that are located in an Area of Interest.

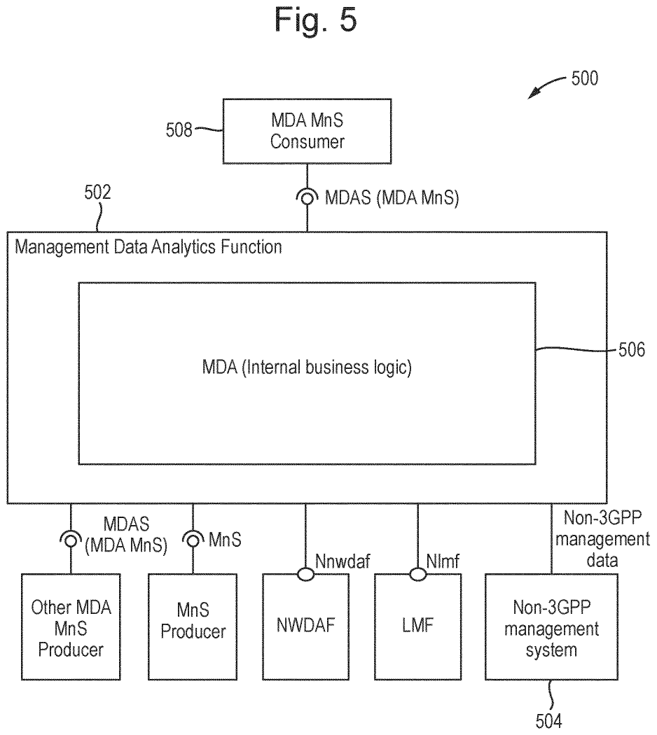

Analytics are also generated at the management plane. The Management Data Analytics (MDA) is an enabler of automation and intelligence for services management and orchestration. An MDA management service (MnS), which is also referred to as MDAS, enables any authorized consumer to request and receive analytics. The MDAS may be as defined in 3GPP TS 28.102 v2.0.0. The architecture associated with the MDAS is shown in FIG. 5. FIG. 5 is a schematic illustration (not to scale) illustrating a conventional MDA functional overview and service framework 500. Further information about this MDA functional overview and service framework 500 may be found in TS 28.104, the contents of which are incorporated herein by reference.

A management function (MDAF) 502 may play the roles of MDA MnS producer, MDA MnS consumer, other MnS consumer, NWDAF consumer, and/or LMF service consumer. The MDAF 502 may interact with other non-3GPP management systems 504.

The internal business logic 506 of the MDAF 502, which is related to MDA, may leverage current and historical data related to one or more of the following:
Performance Measurements (PM), e,g, as per TS 28.552;
Key Performance Indicators (KPIs), e.g. as per TS 28.554;
Trace data, e.g. including Minimization of Drive Tests (MDT) data and/or Radio Link Failure (RLF) data and/or Radio Resource Control (RRC) Connection Establishment Failure (RCEF) data, e.g. as per TS 32.422 and TS 32.423;
Quality of Experience (QoE) and service experience data, e.g as per TS 28.405 and TS 28.406;
Analytics data offered by the NWDAF, e.g. as per TS 23.288, which may include 5GC data and external web/app-based information (e.g., a web crawler that provides online news) from an application function (AF);
Alarm information and notifications, e.g. as per TS 28.532;
Configuration Management (CM) information and notifications;
UE location information provided by an Location Management Function (LMF), e.g. as per TS 23.273;
MDA reports from other MDA MnS producers; and/or
Management data from non-3GPP systems.

Analytics output from the MDA internal business logic are made available by the management functions (MDAFs) playing the role of MDA MnS producers to the authorized consumers 508. The authorized consumers 508 may include, but are not limited to, other management functions, network functions/entities, NWDAF, Self-Organizing Networks (SON) functions, optimization tools, and human operators.

The analytics provided by MDAS may include analytics for fault management predictions and/or statistics. The MDA may include analytics that can assist in fault management. The MDAF and/or the MDA can supervise the status of various network functions and resources, and predict the running trend of network and potential failures to intervene in advance. These predictions can be used by the management system to autonomously maintain the health of the network, e.g., speedy recovery actions on a network function related to the predicted potential failure.

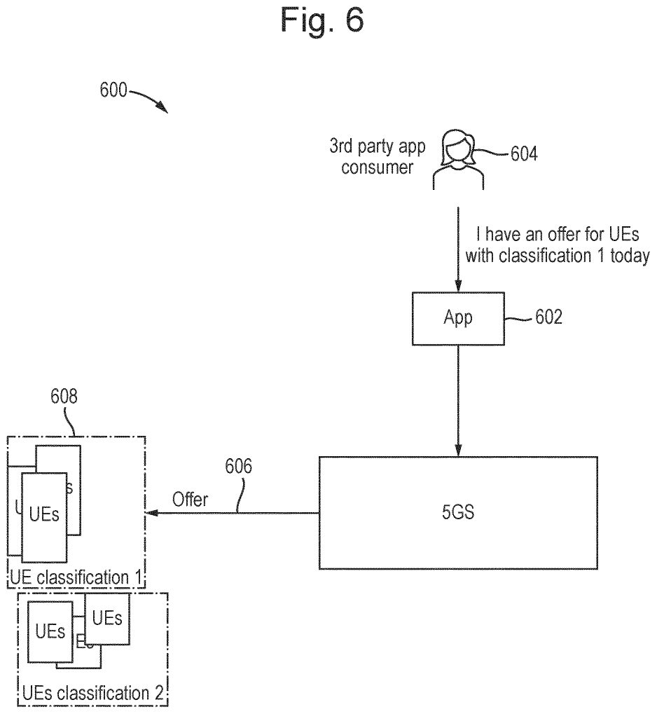

FIG. 6 is a schematic illustration showing a scenario 600 that is currently not fully supported in Release 17 or Release 18 architecture for 5G. The present disclosure provides a solution for the scenario 600 of FIG. 6. In the scenario 600, an operator or application owner can create an application 602 that allows an application consumer 604 (e.g. a business) to advertise service or product offers to users of UE apparatuses (e.g. users of mobile phones) within a given geographical region, e.g. within a given distance (e.g. 1 km) of the geographical location of that business. For example, a business owner may want to advertise a service offering to people passing through, or who are expected to pass through, or those that usually pass through, a 1 km radius around the business location.

From a business perspective, the operator of the application 602 is transformed into a platform operator instead of a service provider. This can lead to new sources of revenue in 5G and beyond.

In the scenario, the consumer 604 wishes to advertise service or product offers to users of UE apparatuses that have a first classification (classification 1, which may for example be UE apparatuses that are likely to be in a first location, location 1, in a given time period, e.g. “today” in this example). The application 602 created by the operator may advertise (i.e., send details of the service or product offers 606) to a list of UE apparatuses that have the first classification 608 (e.g. UE apparatuses that are likely to be in location 1 in the given time period). Preferably, in the scenario 600, the application 602 is provided with a list of UEs that can be provided to the consumer 604, thereby allowing the consumer 604 to select certain features of the UEs it wishes to advertise to. These features can include the combination of any features, such as one or more features selected from the group of features consisting of:
Data networks (DNs) used;
Applications used;
Expected future location used;
Next Generation Node (gNB) used;
edge Data Network Names (DNNs) used;
UE battery remaining;
UE technical characteristics—example screen size, supported media types, make or model, operating system(s), etc.;
Edge network used
Network Slice Instances (NSIs) use; and/or
locations visited or likely to be visited.

Advantageously, this can be achieved without the Operations, Administration and Maintenance entity (OAM) entity exposing internal services or data to the consumer 604.

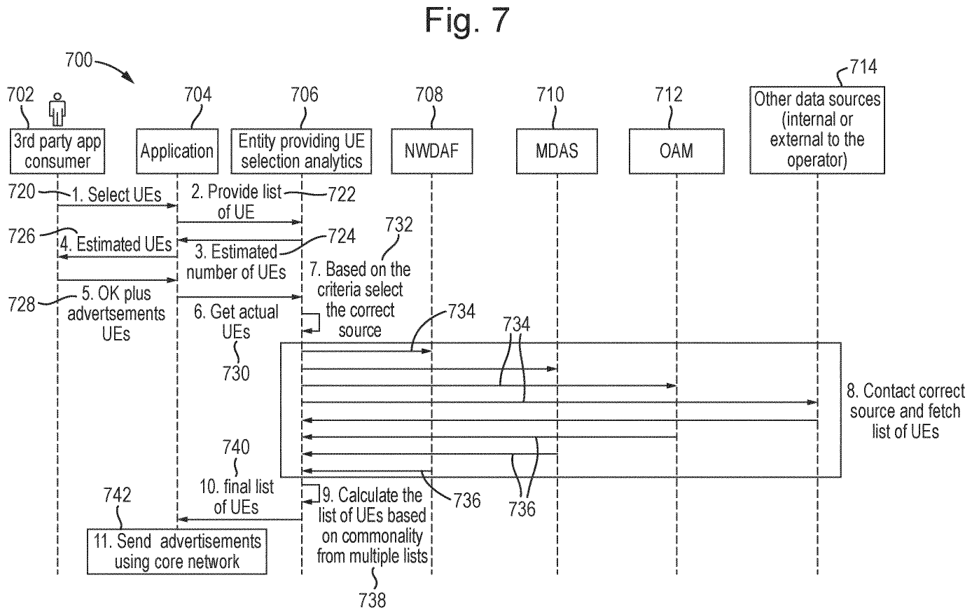

FIG. 7 is a process flow chart showing a method 700 in which a list of UE apparatuses that satisfy one or more selection criteria is provided, according to an embodiment.

The method 700 involves a consumer 702, an application 704, a network entity for providing UE selection analytics (hereinafter referred to as the “selection analytics entity” 706), an NWDAF 708, an MDAS 710, an OAM entity 712, and one or more other data sources 714. The one or more other data sources 714 may be internal or external to an operator of the application 704.

The consumer 702 may be, or may use, a UE apparatus, which may be the same as or in accordance with any of the UEs described herein, such as the UE 200 shown in FIG. 2 and described in more detail earlier above.

The consumer 702, the application 704, the selection analytics entity 706, the NWDAF 708, the MDAS 710, the OAM entity 712, and the one or more other data sources 714 may be the same as or in accordance with any network entity, function, application, or node described herein. For example, the consumer 702, the application 704, the selection analytics entity 706, the NWDAF 708, the MDAS 710, the OAM entity 712, and/or the one or more other data sources 714 may be the same as the network node 300 shown in FIG. 3 and described in more detail earlier above.

In the method 700, it is assumed that the owners or operators of the UE apparatuses to which messages (such as advertisements) are to be sent have consented to receive such messages.

At step 720, the consumer 702 (e.g., an advertiser) requests an advertisement to be sent out to a certain category of users. The consumer 702 sends a first request to the application 704. The first request may be a request that UE apparatuses are selected to receive the advertisement. The first request preferably specifies one or more selection criteria for selecting the UE apparatuses. The selection criteria may include one or more selection criteria selected from the group consisting of:
DNs used by a UE apparatus;
Applications used by a UE apparatus;
Expected future location of a UE apparatus;
A gNB used by a UE apparatus;
Edge DNNs used by a UE apparatus;
UE battery remaining;
One or more UE technical characteristics
An edge network by a UE apparatus;
NSIs used by a UE apparatus;
locations visited or likely to be visited by a UE apparatus;
a QoE experienced by a UE apparatus at a current time or recently (e.g. within a defined previous time period);
an average QoE experienced by a UE apparatus (e.g. over a defined time period);
user authentications used by a UE apparatus;
Subscriber Identity Module (SIM) cards used by a UE apparatus;
any classification useable to choose a set of UEs in the network; and/or
any combination of the above.

At step 722, the application 704 receives the first request and forwards it to the selection analytics entity 706. The first request forwarded to the selection analytics entity 706 may be considered a request for the selection analytics entity 706 to provide, to the application 704, a list of UE apparatuses.

In this embodiment, the selection analytics entity 706 may be part of any other entity in the network, such as the NWDAF 708, the MDAS 710, or the OAM entity 712.

When forwarding the first request, any identifiers (e.g. external identifiers) maybe translated to internal identifiers of the operator (e.g. of the application 704). This translation of external identifiers to internal identifiers of the application 704 may be performed by any entity, such as the application 704.

At step 724, optionally, the selection analytics entity 706 acquires an estimate of a number of UE apparatuses that satisfy the one or more selection criteria specified in the first request. The selection analytics entity 706 may estimate the number of UE apparatuses that satisfy the one or more selection criteria. The selection analytics entity 706 returns, to the application 704, the estimated number of UE apparatuses that satisfy the specified selection criteria.

The estimation of the number of UE apparatuses that satisfy the one or more selection criteria may be performed using any appropriate estimation technique, such as by using historical data and/or using regression.

At step 726, optionally, the application 704 provides the estimated number of UE apparatuses to the consumer 702.

At step 728, the consumer 702 may send a second request to the application 704. The second request may be based on the received estimate. The second request sent from the consumer 702 to the application may comprises one or more of the following:
the number of UE apparatuses to which the advertisement is to be sent (this may be the same as or different to, e.g. lower, than the estimated number of UE apparatuses received by the consumer 702);
consumer approval of the number of UE apparatuses to which the advertisement is to be sent;
the advertisement that is to be sent to the UE apparatuses; and/or
a time duration during which the advertisement is to be sent to the UE apparatuses.

In some embodiments, some or all of this data may be provided in the first request instead of or in addition to being sent in the second request.

In some embodiments, instead of sending the second request, the method may instead return to step 720 and the consumer 702 may send a new first request specifying a different set of selection criteria for the UE apparatuses.

At step 730, the application 704 sends the approved criteria, the advertisement, the number of UE apparatuses to which the advertisement is to be sent (e.g. the number of advertisements to be sent), and the time duration to the selection analytics entity 706. This may be considered to be a request for the selection analytics entity 706 to provide, to the application 704, a final/approved list of UE apparatuses.

At step 732, the selection analytics entity 706 decides which data sources to contact to request one or more lists of UE apparatuses, or other data which can be used to derive the list of UE apparatuses.

In this embodiment, the data sources that can be selected include the NWDAF 708, the MDAS 710, the OAM entity 712, and the one or more other data sources 714. The data sources may be registered with the selection analytics entity 706 or the data sources may be discovered by the selection analytics entity 706, for example via a discovery service.

The selection analytics entity 706 may specify or enable any appropriate identification means for identifying a UE apparatus in a list of UE apparatuses. Example identification means include, but are not limited to a Subscription Permanent Identifier (SUPI), a Generic Public Subscription Identifier (GPSI), and an Internet Protocol (IP) address.

At step 734, the selection analytics entity 706 contacts the one or more selected data sources to request therefrom a list of UE apparatuses. For example, the selection analytics entity 706 may request respective lists of UE apparatuses from one or more of the NWDAF 708, the MDAS 710, the OAM entity 712, and the one or more other data sources 714.

In this embodiment, the selection analytics entity 706 may contact the one or more selected data sources to request one or more of the following:
a list of UE apparatuses that satisfy some or all (for example, a certain subset) of the selection criteria specified by the consumer 702;
a list of UE apparatuses that satisfy some other selection criteria that may later be used, e.g. by the selection analytics entity 706 and/or the application 704, to derive the relevant selection criteria (i.e., the selection criteria specified by the consumer 702) or a list of UE apparatuses that satisfy the relevant selection criteria; or
other data that can then be used, e.g. by the selection analytics entity 706 and/or the application 704, to derive a final list of UE apparatuses that satisfy the one or more selection criteria specified by the consumer 702.

As an example, the selection analytics entity 706 select an external data source, specifically an Internet of Things (IoT) provider, to contact. The selection analytics entity 706 may then contact the IoT provider to request a list of IoT devices which may be installed in a certain area that are capable of receiving the advertisement.

The selection analytics entity 706 may contact the one or more selected data sources to request data indicating the capability of UE apparatuses to receive advertisements. In some embodiments, the selection analytics entity 706 is previously aware of this information.

At step 736, the data sources return the requested lists of UE apparatuses to the selection analytics entity 706.

At step s738, based on the collected data (i.e. using the acquired lists of UE apparatuses), the selection analytics entity 706 determines or compiles a so-called “final” list of UE apparatuses. The final list of UE apparatuses specifies UE apparatuses fulfill or satisfy the one or more selection criteria specified by the consumer 702, and that are technically capable of receiving the advertisement. For example, final list of UE apparatuses may specify the UE apparatuses that are likely to be in a given location at a certain time and that are capable of playing 3D sound.

In some embodiments, the final list of UE apparatuses includes some or all of the UE apparatuses that common to some or all of the respective lists of UE apparatuses received from the data sources.

At step 740, the selection analytics entity 706 provides the final list of UE apparatuses to the application 704.

At step 742, the application 704 uses core network features to send out the advertisement to the UE apparatuses specified in the final list of UE apparatuses. The advertisement may, for example, be sent to the specified UE apparatuses via SMS.

In this embodiment, the application 704 sends the advertisement to the specified UE apparatuses. However, in other embodiment, a different entity, such as the selection analytics entity 706, sends the advertisement to the UE apparatuses specified in the final list of UE apparatuses. In such embodiments, steps 740 and 742 may be omitted,

Advantageously, the systems and methods described herein tend to provide a mobile operator with an ability that allows third party consumers to send advertisements to a certain list of UE apparatuses based on specified criteria. Thus, a platform (multi-sided market) which enables new sources of revenue is provided. This tends to be facilitated or enabled by the selection analytics entity 706, i.e. the entity providing UE analytics, which can combine analytics from both management and control planes, in addition to other data source internal and external to the mobile operator.

In the embodiment described above with reference to FIG. 7, the message that is sent to the UE apparatuses is an advertisement. However, in other embodiments, the message that is sent to the UE apparatuses is a different type of message, such as a public service message, technical data, computer software (e.g. instructions for execution by a processor on a UE apparatus, for example software updates), service offerings, coupons, or discounts. The message may comprise audio, images, video, text, and/or software.

In an embodiment, there is provided a network entity in a wireless communication network. The network entity may be the same as the selection analytics entity 706 described earlier above with reference to FIG. 7. The network entity comprises a receiver arranged to receive information. The information comprises: one or more selection criteria for selecting one or more UE apparatuses, and message information related to one or more messages that are to be sent to one or more UE apparatuses. The network entity further comprises a processor arranged to, using the some or all of the received information, acquire a UE apparatus list (e.g. a “final” list of UE apparatuses). The UE apparatus list indicates one or more UE apparatuses, each of which satisfies the one or more selection criteria and is technically capable of receiving the one or more messages.

The processor may be further arranged to, using some or all of the received information, determine one or more data sources from which to acquire data. The network entity may further comprise a transmitter arranged to send, to each of the determined one or more data sources, a request for the data. The receiver may be further arranged to receive, from the one or more data sources, the requested data. The processor may be further arranged to, using the received data, compile the UE apparatus list.

The processor may be further arranged to, using some or all of the received information, determine one or more data sources from which to acquire a respective initial UE apparatus list. Each initial UE apparatus list may indicate one or more UE apparatuses. For example, each initial UE apparatus list may indicate one or more UE apparatuses that satisfy the one or more selection criteria and which are technically capable of receiving the one or more messages. The network entity may further comprise a transmitter arranged to send, to each of the determined one or more data sources, a request for the respective initial UE apparatus list. The receiver may be further arranged to receive, from the one or more data sources, the one or more initial UE apparatus lists. The processor may be further arranged to, using the one or more initial UE apparatus lists, compile the UE apparatus list, the UE apparatus list indicating one or more of the UE apparatuses indicated in the one or more initial UE apparatus lists.

The one or more data sources are selected from the group of data sources consisting of: a NWDAF, a MDAS, an OAM entity; an IoT provider; an internal data source of an operator; an external data source of an operator; and an NF in the wireless communication network. The data sources may be determined by registration with the network entity, or via a discovery service.

The transmitter may be further arranged to send the UE apparatus list to another network entity (e.g. an application, such as the application 704, or an entity that requests the UE apparatus list).

The transmitter may be further arranged to send, to each of the one or more UE apparatuses indicated by the UE apparatus list, the one or more messages.

The one or more selection criteria may comprise one or more selection criteria selected from the group of selection criteria consisting of: one or more data network used by a UE apparatus; one or more applications used by a UE apparatus; an expected future location of a UE apparatus; a current location by a UE apparatus; one or more Next Generation Node Bs, gNBs, used by a UE apparatus; one or more edge Data Network Names, DNNs, used by a UE apparatus; a remaining battery level of a UE apparatus; a screen size of a UE apparatus; a make and/or model of a UE apparatus; an operating system of a UE apparatus; one or more edge networks used by a UE apparatus; one or more Network Slice Instances, NSIs, used by a UE apparatus; one or more locations visited by a UE apparatus; one or more locations likely to be visited by a UE apparatus; a Quality of Experience, QoE, experienced by a UE apparatus; an average QoE experienced by a UE apparatus; one or more user authentications used by a UE apparatus; one or more Subscriber Identity Module, SIM, cards used by a UE apparatus; and a classification of a UE apparatus.

The processor may be further arranged to, using the one or more selection criteria, determine an estimate of a number of UE apparatuses that satisfy the one or more selection criteria. The transmitter may be further arranged to send the estimate to another network entity (e.g. an application, such as the application 704, or an entity that requests the UE apparatus list).

The message information may comprises information selected from the group consisting of: the one or more messages; the number of messages that are to be sent to one or more UE apparatuses; and a time duration during which the one or more messages are to be sent to one or more UE apparatuses.

The UE apparatus list may identify a UE apparatus using one or more UE apparatus identifiers selected from the group of UE apparatus identifiers consisting of: a SUPI; a GPSI; and an IP address.

The network entity may be collocated with one or more of the following entities: an NWDAF; a MDAS; an OAM entity; an Io'T provider; or a NF in the wireless communication network.

The one or more messages may comprise an advertisement, a public service announcement, technical data, computer software (such as a software update), an executable, audio data, video data, text data, numerical data, etc.

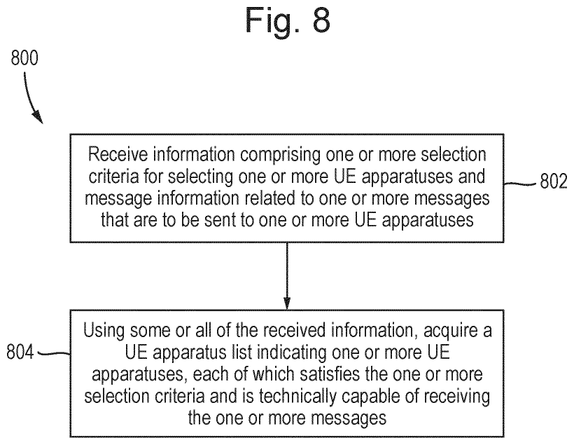

In a further embodiment, there is provided a method performed in a wireless communication network. FIG. 8 is a process flow chart showing certain steps of this method 800. The method 800 may be performed by a network entity such as the selection analytics entity 706 described earlier above with reference to FIG. 7. The method 800 comprises: receiving 802 information comprising one or more selection criteria for selecting one or more UE apparatuses and message information related to one or more messages that are to be sent to one or more UE apparatuses; and, using the some or all of the received information, acquiring 804 (e.g. compiling) a UE apparatus list, the UE apparatus list indicating one or more UE apparatuses, each of which satisfies the one or more selection criteria and is technically capable of receiving the one or more messages.

In a further embodiment, there is provided a network entity in a wireless communication network. The network entity may be the same as the application 704 described earlier above with reference to FIG. 7. The network entity comprises a receiver arranged to receive information. The information comprises one or more selection criteria for selecting one or more UE apparatuses, and message information related to one or more messages that are to be sent to one or more UE apparatuses. The network information further comprises a transmitter arranged to send, to a further entity in wireless communication network (such as the selection analytics entity 706 described earlier above with reference to FIG. 7), a request for a UE apparatus list, the UE apparatus list indicating one or more UE apparatuses each of which satisfies the one or more selection criteria and each of which is technically capable of receiving the one or more messages. The receiver is further arranged to receive, from the further entity, the UE apparatus list.

The transmitter may be further arranged to send, to each of the one or more UE apparatuses indicated by the UE apparatus list, the one or more messages.

The transmitter may be further arranged to send to, to the further entity, a request for an estimate of a number of UE apparatuses that satisfy the one or more selection criteria. The receiver may be further arranged to receive to, from the further entity, the estimate. The transmitter may be further arranged to send to the estimate to a second further entity in the wireless communication network (such as the consumer 702 described earlier above with reference to FIG. 7). The second further entity may be a network entity from which the information is received. The receiver may be further arranged to receive a confirmation of the selection criteria and/or the number of messages to be sent and/or the messages in response to the estimate being transmitted. The request for a UE apparatus list may be based on that confirmation.

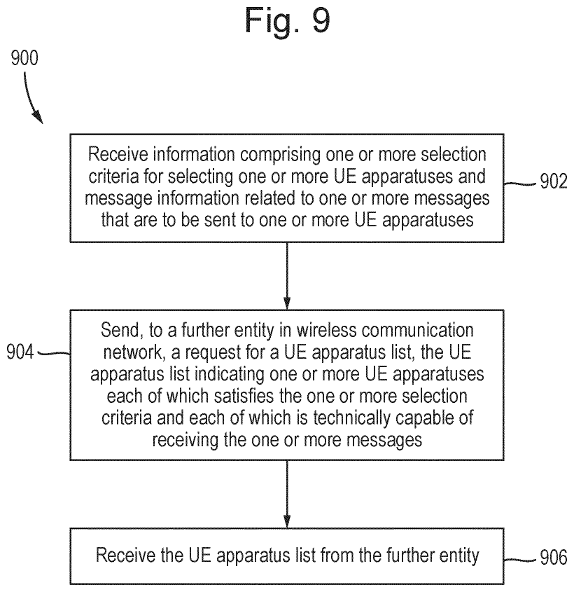

In a further embodiment, there is provided a method performed in a wireless communication network. FIG. 9 is a process flow chart showing certain steps of this method 900. The method 900 may be performed by a network entity such as the application 704 described earlier above with reference to FIG. 7. The method comprises receiving 902 information. The information comprises one or more selection criteria for selecting one or more UE apparatuses and message information related to one or more messages that are to be sent to one or more UE apparatuses. The method further comprises sending 904, to a further entity in wireless communication network, a request for a UE apparatus list, the UE apparatus list indicating one or more UE apparatuses each of which satisfies the one or more selection criteria and each of which is technically capable of receiving the one or more messages. The method further comprises receiving 906, from the further entity, the UE apparatus list.

In an embodiment, there is provided an application for sending advertisements to UE apparatuses.

In an embodiment, there is provided a network entity that can provide a list of UEs given certain selection criteria. The entity may be confirmed to, based on the selection criteria, determine which data to gather from which data sources, and to contact said data sources to gather that data. Examples of the data sources include but are not limited to an NWDAF, an MDAS, an OAM entity, an internal data source of the operator, a data sources external to the operator. The entity may be arranged to, based on the received data, generate a list of UEs satisfying the original selection criteria. The entity may be collocated with an NWDAF, an MDAS, an OAM entity, or any other NF in the network.

In an embodiment, there is provided a method of sending advertisements to a selected set of UEs based on a combination of selection criteria.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network entity in a wireless communication network, the network entity comprising:
a memory; and
a processor coupled with the memory and configured to cause the network entity to:
receive information comprising:
one or more selection criteria for selecting one or more user equipments (UEs); and
one or more messages that are to be sent to one or more UEs; and
acquire a UE list indicating one or more UEs, wherein each UE of the one or more UEs satisfies the one or more selection criteria and is capable of receiving the one or more messages.

2. The network entity of claim 1, wherein the processor is configured to cause the network entity to:
determine one or more data sources from which to acquire data based at least in part on the received information;
transmit, to each of the determined one or more data sources, a request for the data;
receive, from the one or more data sources, the requested data; and
compile the UE list based at least in part on the received data.

3. The network entity of claim 1, wherein the processor is configured to cause the network entity to:
determine one or more data sources from which to acquire a respective initial UE list based at least in part on the received information, each initial UE list indicating one or more UEs;
transmit, to each of the one or more data sources, a request for the respective initial UE list;
receive, from the one or more data sources, the one or more initial UE lists; and
compile the UE list based at least in part on the one or more initial UE lists, the UE list indicating one or more of the UEs indicated in the one or more initial UE lists.

4. The network entity of claim 1, wherein the processor is configured to cause the network entity to transmit the UE list to another network entity.

5. The network entity of claim 1, wherein the processor is configured to cause the network entity to transmit the one or more messages to each of the one or more UEs indicated by the UE list.

6. The network entity of claim 1, wherein the one or more selection criteria comprise one or more of:
one or more data network used by a UE;
one or more applications used by the UE;
an expected future location of the UE;
a current location by the UE;
one or more Next Generation Node Bs (gNBs);
one or more edge Data Network Names (DNNs);
a remaining battery level of the UE;
a screen size of the UE;
a make or model of the UE;
an operating system of the UE;
one or more edge networks used by the UE;
one or more Network Slice Instances (NSIs) used by the UE;
one or more locations visited by the UE;
one or more locations likely to be visited by the UE;
a Quality of Experience (QoE) experienced by the UE;
an average QoE experienced by the UE;
one or more user authentications used by the UE;
one or more Subscriber Identity Module (SIM) cards used by the UE; or
a classification of the UE.

7. The network entity of claim 1, wherein the processor is configured to cause the network entity to:
determine an estimate of a number of UEs that satisfy the one or more selection criteria; and
transmit the estimate to a network application entity.

8. The network entity of claim 1, wherein the received information further comprises message information related to the one or more messages, the message information comprising:
a number of messages that are to be sent to the one or more UEs; or
a time duration during which the one or more messages are to be sent to the one or more UEs.

9. The network entity of claim 1, wherein the UE list identifies a UE using one or more of:
a Subscription Permanent Identifier (SUPI);
a Generic Public Subscription Identifier (GPSI); or
an Internet Protocol (IP) address.

10. The network entity of claim 2, wherein the one or more data sources comprise one or more of:
a Network Data Analytics Function (NWDAF);
a Management Data Analytics Service (MDAS);
an Operations, Administration and Maintenance (OAM) entity;
an Internet of Things (IoT) provider;
an internal data source of an operator of the network entity;
an external data source of an operator of the network entity; or
a network function (NF) in the wireless communication network.

11. The network entity of claim 1, wherein the network entity is collocated with one or more of the following entities:
a Network Data Analytics Function (NWDAF);
a Management Data Analytics Service (MDAS);
an Operations, Administration and Maintenance (OAM) entity;
an Internet of Things (IoT) provider; or
a network function (NF) in the wireless communication network.

12. The network entity of claim 1, wherein the one or more messages comprise an advertisement or a public service message, technical data, and/or computer software.

13. A method performed by a network entity in a wireless communication network, the method comprising:
receiving information comprising:
one or more selection criteria for selecting one or more user equipments (UEs); and
one or more messages that are to be sent to one or more UEs; and
acquiring a UE list based at least in part on the received information, the UE list indicating one or more UEs, wherein each UE of the one or more UEs satisfies the one or more selection criteria and is capable of receiving the one or more messages.

14. A network entity in a wireless communication network, the network entity comprising:
a memory; and
a processor coupled with the memory and configured to cause the network entity to:
receive information comprising:
one or more selection criteria for selecting one or more user equipments (UEs); and
one or more messages that are to be sent to one or more UEs; and
transmit, to a further entity in the wireless communication network, a request for a UE list based at least in part on the received information, the UE list; and
receive, from the further entity, the UE list indicating one or more UEs, wherein each UE of the one or more UEs satisfies the one or more selection criteria and each of which is capable of receiving the one or more messages.

15. The network entity of claim 14, wherein the processor is configured to cause the network entity to transmit the one or more messages to each of the one or more UEs indicated by the UE list.

16. The network entity of claim 14, wherein the processor is configured to cause the network entity to:
transmit, to the further entity, a request for an estimate of a number of UEs that satisfy the one or more selection criteria;
receive the estimate from the further entity; and
transmit the estimate to a second further entity in the wireless communication network.

17. A method performed by a network entity in a wireless communication network, the method comprising:
receiving information, the information comprising:
one or more selection criteria for selecting one or more user equipments (UE); and
one or more messages that are to be sent to one or more UEs;
transmitting, to a further entity in wireless communication network, a request for a UE list based at least in part on the received information, the UE list; and
receiving, from the further entity, the UE list indicating one or more UEs, wherein each UE of the one or more UEs satisfies the one or more selection criteria and each of which is capable of receiving the one or more messages.

18. The network entity of claim 14, wherein the one or more selection criteria comprise one or more of:
one or more data network used by a UE;
one or more applications used by the UE;
an expected future location of the UE;
a current location by the UE;
one or more Next Generation Node Bs (gNBs) used by the UE;
one or more edge Data Network Names (DNNs) used by the UE;
a remaining battery level of the UE;
a screen size of the UE;
a make and/or model of the UE;
an operating system of the UE;
one or more edge networks used by the UE;
one or more Network Slice Instances (NSIs) used by the UE;
one or more locations visited by the UE;
one or more locations likely to be visited by the UE;
a Quality of Experience (QoE) experienced by the UE;
an average QoE experienced by the UE;
one or more user authentications used by the UE;
one or more Subscriber Identity Module (SIM) cards used by the UE; or
a classification of the UE.

19. The network entity of claim 14, wherein the received information further comprises message information related to the one or more messages, the message information comprising:
a number of messages that are to be sent to the one or more UEs; or
a time duration during which the one or more messages are to be sent to the one or more UEs.

20. The network entity of claim 14, wherein the UE list identifies a UE using one or more of:
a Subscription Permanent Identifier (SUPI);
a Generic Public Subscription Identifier (GPSI); or
an Internet Protocol (IP) address.
